(19) United States
(12) Patent Application Publication
(10) Pub. No.: US 2003/0055720 A1
(43) Pub. Date: Mar. 20, 2003

(54) Method and system for tracking legislative activity

(76) Inventors: Joseph P. Overton, Midland, MI (US); David Matson, Hope, MI (US)

Correspondence Address: Michael N. Haynes, Esq., 1341 Huntersfield Close, Keswick, VA, 22947, US

(21) Appl. No.: 10/241,978

(22) Filed: Sep. 12, 2002

Related U.S. Application Data
(60) Provisional application No. 60/322,782, filed on Sep. 17, 2001.

(51) Int. Cl. G06F 17/60

(52) U.S. Cl. 705/12

(57) ABSTRACT

Certain embodiments of a method for tracking legislative activities are disclosed. Certain disclosed embodiments can include the actions of rendering a user interface via which a database can be populated with information regarding a legislative activity, the user interface comprising data entry elements for individual legislator voting information, legislative activity identifier, and legislative activity description, and populating the database with the information regarding the legislative activity. It is emphasized that this abstract is provided to comply with the rules requiring an abstract that will allow a searcher or other reader to quickly ascertain the subject matter of the technical disclosure. This abstract is submitted with the understanding that it will not be used to interpret or limit the scope or meaning of the claims. 37 CFR 1.72(b).

### CROSS-REFERENCE TO RELATED APPLICATIONS

This application claims priority to, and incorporates by reference herein in its entirety, pending provisional application Serial No. 60/322,782, (Attorney Docket No. 1006-002), filed Sep. 17, 2001.

### BRIEF DESCRIPTION OF THE DRAWINGS

The invention and its wide variety of potential embodiments will be more readily understood through the following detailed description of certain exemplary embodiments, with reference to the accompanying drawings, in which:

FIG. 1 is a flowchart of an exemplary embodiment of a method 100 of the present invention;

FIG. 2 is a block diagram of an exemplary embodiment of a system 200 of the present invention;

FIG. 3 is a block diagram of an exemplary embodiment of an information device 300 of the present invention; and

FIG. 4 is a diagram of an exemplary embodiment of a user interface 400 of the present invention.

FIG. 5 is a diagram of an exemplary embodiment of a user interface 500 of the present invention.

FIG. 6 is a diagram of an exemplary embodiment of a user interface 600 of the present invention.

### DETAILED DESCRIPTION

The promises of a free and democratic society hinge, at least partially, upon a truly representative government. Inherent in such a government are properly elected representatives whose voting and activities accurately reflect the needs and/or desires of their constituency. Also inherent is a citizenry free to engage in constructive social change without the violence, fear, cynicism, and/or apathy that citizens of many countries experience daily.

In the United States of America, however, legislative activity traditionally has been obscured from the average citizen by a smoky veil of obtuse jargon, arcane procedure, and lax reporting. These impediments have often prevented most US citizens from becoming sufficiently informed to develop a comfort and/or motivation to participate in the public arena as fully as they might otherwise do.

For example, legislative activities are often recorded in journals. These journals and their records are frequently poorly presented, poorly worded, unclear, and/or difficult to comprehend, access, search, and/or assimilate. Consequently, obtaining an understanding of the underlying legislative activities is effectively unavailable and/or under-available to many voters, citizens, and/or constituents, etc. who might otherwise be interested in the activities of the associated legislators. Such legislative activities can include any of numerous activities involving legislation, e.g., introducing, holding hearings on, analyzing, revising, substituting, reporting, debating, commenting upon, amending, voting on, approving, and/or vetoing the legislation.

Certain exemplary embodiments of the present invention are designed to inform community leaders, businesspeople, news media, public officials, and/or the general public about legislative activities that impact their families, schools, businesses, and/or communities. Certain exemplary embodiments of the present invention also can assist citizens and/or others who wish to take an active part in the democratic process and hold their elected representatives accountable for their actions.

Certain exemplary embodiments of the present invention can provide a legislative activities tracking system that includes a legislative activities database that can be populated with information concerning upcoming, current, and/or past legislative activities. The database can be accessible, at least for certain purposes, via a website. For example, the database can be populated via entry of data through data entry elements of a graphical user interface rendered on a website. As another example, the database can be queried via query elements of a graphical user interface rendered on a website.

Via certain exemplary embodiments of the present invention, when legislation (referred to herein as a “bill”) is introduced, that bill can be reviewed, analyzed, distilled, summarized, described, and/or noted in the database. Thereafter, descriptions and pertinent information regarding any and/or all activities related to the bill can be recorded in the database, those activities potentially including, for example, committee actions, substitutes, amendments, final votes, and/or gubernatorial veto or approval, etc. Consequently, via the legislative activities website and/or database, complete voting records for any legislator and any legislative activities can be rendered, so citizens can see where their elected representatives stand.

In certain exemplary embodiments of the present invention, a method is provided whereby, upon introduction of legislation via a bill or the like, and sometimes referred to herein as a “bill”, certain information about that bill is populated in the legislative activities database. That information can include:

the bill identifier, such as a bill number;

the name of the legislator who sponsors or sponsored the bill;

the date of the bill's introduction;

the session during which the bill was introduced;

the chamber in which the bill was introduced (e.g., House or Senate); and/or

the title of the bill.

Moreover, the content of the bill can be analyzed, interpreted, and/or distilled to provide a description of the bill, which can be summary and/or abstract, for the legislative activities database. That description can be designed to be highly readable and/or comprehendible by the average citizen, by, for example, being short, jargon-free, and/or to the point. In addition, the bill can be assigned to one or more subject matter categories.

Once introduced, the bill can be tracked, and the legislative activities database populated with information relating to the progress and/or status of the bill. For example, information can be gathered and included in the legislative activities database regarding:

the procedural posture of the bill;

any committee which is currently handling the bill;

suggested, offered, voted upon, and/or implemented amendments to the bill;

sponsors and/or co-sponsors of suggested, offered, voted upon, and/or implemented amendments to the bill;

suggested, offered, voted upon, and/or implemented substitutions for the bill;

individual legislator voting information regarding the bill, including, for example, for each legislator:

if the legislator voted,

if the legislator abstained from voting,

if the legislator was excused from voting,

if the legislator did not vote,

if the legislator was not present to vote,

date of voting,

method of voting, and/or

vote type (e.g., “yea” or “nay”), etc.; and/or

executive approval or veto of the bill, etc.

Consequently, certain exemplary embodiments of the legislative activities website of the legislative activity tracking system of the present invention can be utilized to query the legislative activities database for information about the bill. For example, certain exemplary embodiments of the legislative activity database can include voting records for each and every legislator, over any selected period of time, for bills having any procedural posture. Thus, a user could, for example, search for and find all instances during the past 7 months in which their particular legislator voted against allowing bills related to agriculture from being referred out of committee for a vote of the full legislature. As another example, a user could search for and find all instances during the past 2 years in which a selected legislator did not vote when presented the opportunity.

The user interface of the legislative activities website can be designed to be approachable, intuitive, and/or user-friendly. For example, a “basic search” user interface can include graphical elements such as buttons having pop-up choice lists for:

legislative session;

House representative (legislator);

Senate representative (legislator); and/or

topic, etc.

The basic search user interface can include links to one or more web pages that enable the user to determine their legislator and/or the legislator(s) for any given geographical area. The basic search user interface can also include buttons to initiate a search and/or to reset the choices in the pop-up choice lists. Further, the basic search user interface can be personalized by the user so that the interface always initially presents information regarding recent votes of the user's legislators.

An “advanced search” user interface can provide additional and/or alternative graphical user interface elements. For example, an advanced search user interface can include user interface elements for:

keywords;

date range; and/or

bill identifier (e.g., number); etc.

Additional user interfaces can be provided for creating, maintaining, managing, and/or querying the legislative activities database and/or the information contained therein.

Yet additional user interfaces can be provided for a user to enter, edit, and/or view comments concerning a bill and/or legislative activities. For example, assume a user wants to share with others her opinion regarding a bill directed toward banning a specific breed of dog. The user could enter her comments in a comment box of a comment user interface, could edit those comments prior to and/or after submission, and could view the comments of other users regarding the same topic and/or discussion thread. Similarly, if a sponsor of a bill wanted to explain why the bill was introduced, that sponsor could post a comment that would be linked to information regarding the bill.

A moderator can be responsible for viewing all comments, directing the discussion, and/or chastising and/or disengaging users whose comments are inappropriate and/or outside the terms of use for the legislative activity tracking system. A user interface can be provided for any or all of these moderator functions.

A user interface and/or user interface elements can be provided by which comments (including facts, opinions, and/or feedback, etc.) regarding a bill or legislative activities can be submitted to a legislator, executive, or other chosen entity (e.g., a special interest group, political action committee, candidate, polling organization, etc.). Thus, for example, the user having comments regarding a bill directed toward banning a specific breed of dog can enter her comments in a comment box of a comment user interface. Also, the user interface can allow the user to edit the comments prior to and/or after submission, and/or direct the comments toward her legislator(s), the sponsor of the bill, other legislators, and/or the chief executive having responsibility for approving or vetoing the legislation.

Moreover, a user interface can be provided for a user to request notification when a new legislative activity regarding one or more bills and/or topics occurs. Such notification can be via any known communication method, including, for example, mail, telegraph, fax, telephone, pager, instant messaging, voice-mail, e-mail, web page update, and/or push technology. For example, a user can be paged when a committee has voted on a bill of interest to the user, and/or the user could receive the results of that committee's vote via an instant message.

Certain exemplary embodiments of the legislative activity tracking system of the present invention could provide, allow a user to provide, and/or allow a third party to provide, a rating of the voting history of one or more legislators against a scale or index provided by the rater. For example, the ACLU could measure a legislator against a “Supports Civil Rights” scale, or the NRA could rate a state's Republican legislators against one or more “2nd Amendment” criteria. As another example, an individual could design her own rating criteria against which one or more legislators are measured, scored, rated, and/or ranked.

In one illustrative embodiment, to develop such a rating, the legislative activity database could be accessed, and perhaps searched, and pertinent data downloaded to an analytical tool, such as a spreadsheet, programmed to perform the rating. Each legislative activity of interest then can be assessed with respect to an “issue”, such as “capital punishment”, and an appropriate rating of the activity entered into the spreadsheet.

As another example, an Application Service Provider (ASP) model could be developed, whereby a spreadsheet-like tool is provided on the legislative tracking website. That spreadsheet can be designed by the rater to include certain calculations and/or analytical tools. As an example, a rater could create a spreadsheet that calculates an “activity level” of a legislator, where the activity level can include the number of roll call votes attended, the number of bills sponsored or co-sponsored, the number of amendments introduced, etc. As another example, a statistical analysis of legislative activities could be performed, whereby one legislator is compared to an average or mode of legislators. As a further example, an analysis of the total amount of appropriations bills voted for or against by a legislator could assist in rating the legislator's spending habits versus an index or against other legislators. In any event, the results of the analysis can be presented numerically, textually (such as “frequently votes conservative on fiscal matters” or “a friend of the environment”), or graphically.

The ability to analyze legislative activities can provide a tool for opposition research, whereby a candidate analyzes an incumbent for weaknesses that can be exploited during a political campaign.

Certain exemplary embodiments of the legislative activity tracking system of the present invention could be extended to include legislative activities from all states or provinces, the national level, or even the municipal or county level. Thus, an individual or organization interested in tracking legislative activities related to fireworks could search the “USAVotes.org” database for legislative activities occurring in any legislative forum relating to fireworks. Moreover, one could track the voting history of a given individual as that individual moved from office to office.

Similarly, certain exemplary embodiments of the legislative activity tracking system of the present invention could be extended to track legislative activities in other countries, or at the international level. Moreover, to the extent that non-governmental entities operate on a representative basis, certain exemplary embodiments of the legislative activity tracking system of the present invention could be extended to track activities of those representative entities. For example, assume the American Medical Association is an organization whose internal activities are performed by elected representatives. Assuming also that those activities are intended to be “open” for viewing by the members of the AMA, then an “AMAVotes.org” web site and database could be created to allow those members to track those representatives' activities. In the event that those activities are intended to be non-public and only visible to members of the organization, appropriate security measures, such as password protection, access control lists, etc., could be implemented to prevent unauthorized viewing of information about those activities. Further, the legislative activity tracking system of the present invention could be additionally extended to provide tracking of internal activities for any public or private enterprises of any sort, provided that information about those activities was only made available to authorized individuals, such as members of a board of directors, managers at a particular level, managers of a particular department, members of a given team, etc.

In the legislative environment, certain exemplary embodiments of the legislative activity tracking system of the present invention could be extended to track committee activity, so that legislative activities can be tracked at an earlier stage.

As a further development of the previous concept, a “watch” feature could be initiated, whereby a user can enter a description of legislative activities topics or bill number (or other criteria) of interest, and the system can notify the user when legislative action matching the description arises. A “thesaurus” feature could extend entered descriptions to related phrases and/or words.

The “watch” feature could be further expanded to include a “calendar” feature that lists scheduled and/or expected dates for future action on the bill and/or other legislative activities. Extending this concept even further, a “probability” could estimate the likelihood that the bill will pass any known and/or expected procedural hurdles, and the timeframe in which it might do so.

The “notification” aspect of the “watch” feature could also be augmented by allowing the notification to be sent, e.g., via e-mail, to a user-designated list of individuals. This notification could include a user-authored message that might be intended to inspire action on behalf of the receivers. For example, if a user received a notification indicating that a bill was emerging to ban a specific breed of dog, the user could draft a “call to arms” message to attach to the notification, urging receivers of the forwarded message to contact their legislator to reject the proposed bill. The original notification could include contact information for pertinent legislators, or one or more hypertext links for receivers to activate to determine their own legislators.

Another enhancement could provide trend charts showing how many pieces of legislation related to a particular topic were introduced in each of several sequential time periods. Alternatively, and/or in addition, trend charts could be provided showing legislative activities related to a particular topic. Thus, one could view a graphical representation showing an increasing legislative interest in a particular topic.

Yet another enhancement could be the entry into the legislative activities database of information regarding legislative activities from previous sessions, including those of many years ago. One valuable use for such information is the ability to quickly survey and identify all introduced, passed, and/or vetoed bills related to a particular topic, such as all executive-signed bills (laws) that relate to visitation rights for grandparents.

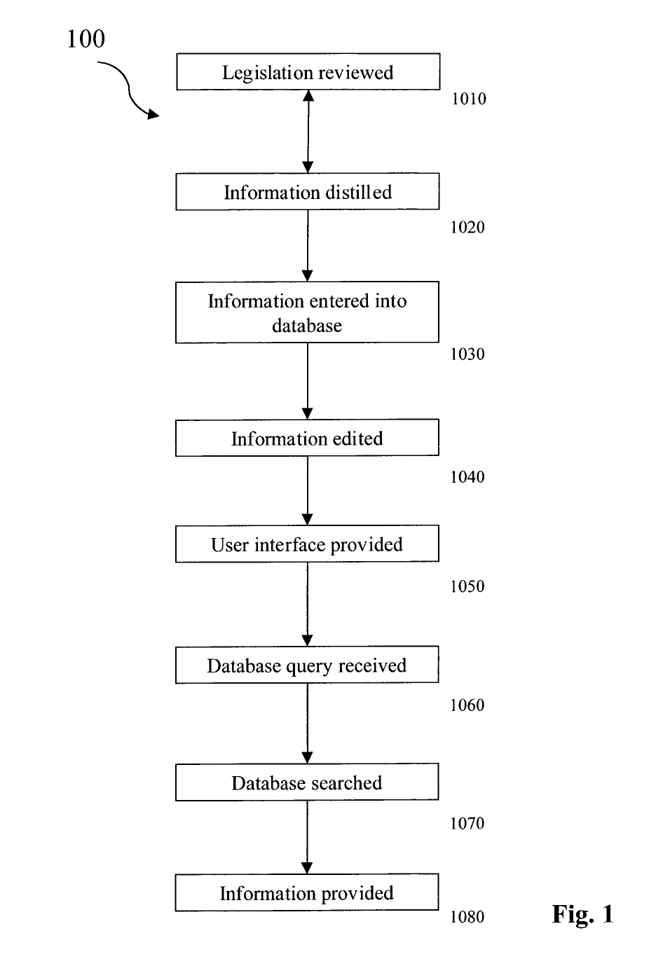

FIG. 1

FIG. 1 is a flowchart of an exemplary method 100 of the present invention. As shown at action 1010, method 100 can include the review of one or more legislative activities. As shown at action 1020, information about the one or more legislative activities can be distilled from the bill or other communication regarding the legislative activities. As shown at action 1030, the distilled information can be entered into a legislative activities database. As shown at action 1040, information in the legislative activities database can be edited. As shown at action 1050, a user interface for querying the database can be provided. As shown at action 1060, a query for the database can be received. As shown at action 1070, the database can be automatically searched in reaction to the query. As shown at action 1080, information about the legislative activities can be rendered in response to the query. As used herein, the term “rendered” means displayed, annunciated, spoken, printed, and/or otherwise made perceptible to a human.

In certain embodiments, the legislative tracking system can be adapted to automatically alert a legislator when a comments has been posted regarding a bill that legislator is sponsoring, supporting, opposing, and/or interested in. In certain embodiments, a first committee can be notified when a second committee takes action on a bill in an manner that will impact upon the tasks and/or schedule of the first committee.

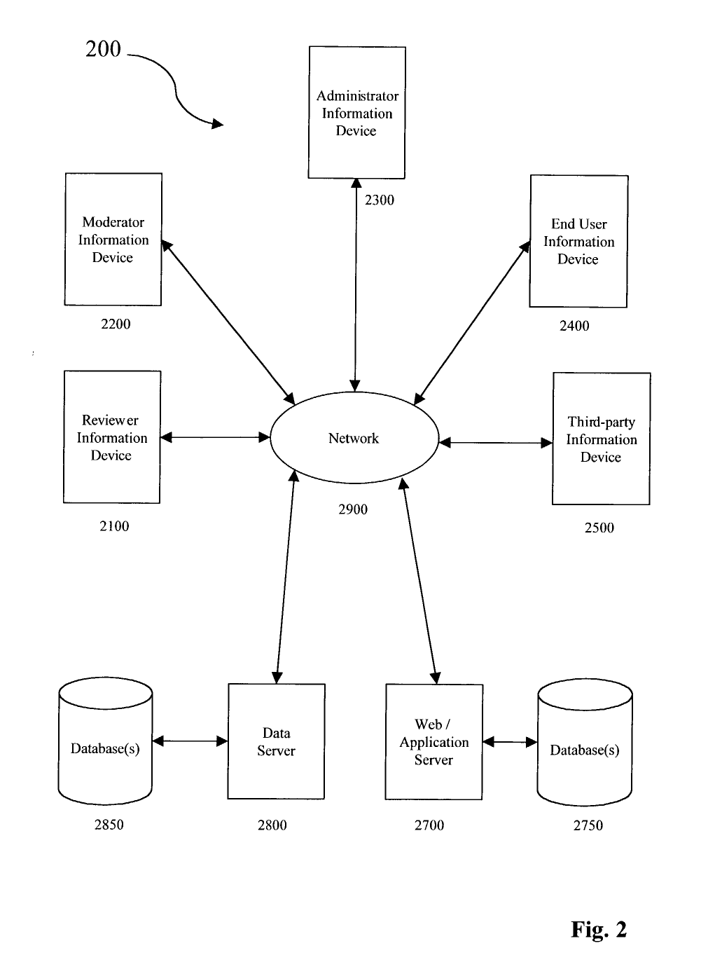

FIG. 2

FIG. 2 provides a block diagram of an exemplary embodiment of a system 200 of the present invention. As an initial matter, it suffices to say that, using the description of method 100, one of ordinary skill in the art can implement the functionality of method 100 via system 200 utilizing any of a wide variety of well-known architectures, hardware, protocols, and/or software. Thus, the following description of system 200 can be viewed as illustrative, and should not be construed to limit the implementation of method 100.

Within system 200, a reviewer information device 2100 can be used by a reviewer to enter and/or communicate regarding one or more bills, legislative activities, and/or laws with various other information devices (e.g., moderator information device 2200, administrator information device 2300, etc.), with web/application server 2700, and/or with data server 2800. Reviewer information device 2100 can also be used to manage databases, query databases, enter legislative activities information, etc.

Reviewer information device 2100 can be connected to network 2700. Also connected to network 2900 can be various other information devices 2200-2500, at least some of which can be used, for example, to manage web/application database(s) 2750, manage legislative activities database(s) 2850, query databases, etc.

Examples of uses of information devices 2200-2500 follow. Moderator information device 2200 can be used by a moderator to moderate discussions and/or comments regarding legislative activities, disengage a user whose comments violate an acceptable use policy for the legislative activity tracking system, etc. Administrator information device 2300 can be used by an administrator an embodiment of the legislative activity tracking system of the present invention to, for example, add, edit, or delete legislative activities topics, committees, legislative sessions, user accounts, user profiles, user types, political parties, etc.

End user information device 2400 can be used by an end user of an embodiment of the legislative activity tracking system of the present invention to, for example, create or edit the user's profile, queries of the legislative activities database, and/or comments on legislative activities, etc. Third-party information device 2500 can be used by a third party, such as a government organization, to provide the content of a bill, for example.

Web/application server 2700 and/or data server 2800 also can be connected to network 2900 and can be used to host one or more databases 2750, 2850, serve files, serve e-mail, etc. Servers 2700, 2800 can be one or more computing devices of any sort. In fact, servers 2700, 2800 can run on a single computing device or on multiple computing devices. Any of information devices 2100-2500 can be used to host one or more databases (not shown).

Network 2900 can electronically link physically distant information devices 2100-2500, web/application server 2700, and/or data server 2800, so that information can be transmitted and/or exchanged there between. Network 2900 can have any architecture, including a direct connection, a local area network, a wide area network such as the public switched telephone network and/or the Internet, an extranet, and/or a combination thereof. Network 2900 can be a packet-switched, a circuit-switched, a connectionless, or connection-oriented network or interconnected networks, or any combination thereof. Network 2900 can be oriented toward voice, data, or voice and data communications. Moreover, a transmission media of network 2900 can take any form, including wireline, satellite, wireless, or a combination thereof.

From a hardware standpoint, any information device, including reviewer information device 2100 and/or any other information device 2200-2500, can be, for example, a landline or wireless telephone, facsimile, personal computer, personal information manager, personal digital assistant, handheld computer, data terminal, or other similar device.

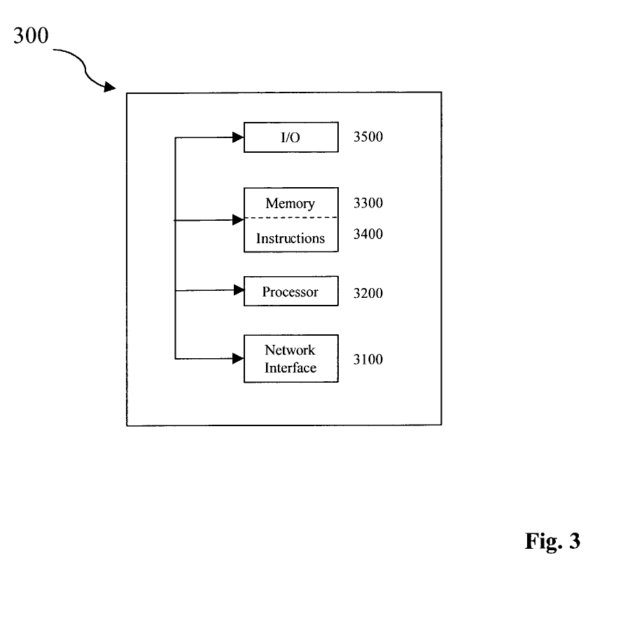

FIG. 3

FIG. 3 is a block diagram of an exemplary and typical information device 300, which can symbolize any information device 2100-2500, and/or any server 2700, 2800. Information device 300 can include well-known components such as one or more network interfaces 3100, one or more processors 3200, one or more memories 3300 containing instructions 3400, and/or one or more input/output (I/O) devices 3500, etc.

In one embodiment, network interface 3100 can be a telephone, a traditional data modem, a fax modem, a cable modem, a digital subscriber line interface, a bridge, a hub, a router, or other similar devices.

Each processor 3200 can be a general purpose microprocessor, such the Pentium III series of microprocessors manufactured by the Intel Corporation of Santa Clara, Calif. In another embodiment, the processor can be an Application Specific Integrated Circuit (ASIC) which has been designed to implement in its hardware and/or firmware at least a part of a method in accordance with an embodiment of the present invention.

Memory 3300 can be coupled to a processor 3200 and can store instructions 3400 adapted to be executed by processor 3200 according to one or more actions of method 100. Memory 3300 can be any device capable of storing analog or digital information, such as a hard disk, Random Access Memory (RAM), Read Only Memory (ROM), flash memory, a compact disk, a magnetic tape, a floppy disk, and any combination thereof.

Instructions 3400 can be embodied in software, which can take any of numerous forms that are well-known in the art. For example, system 200 can utilize one or more databases having a flat file or a relational organization, and a centralized or distributed architecture. For instance, those of skill in the art can tailor items such as an SQL database to provide the functionality of method 100 and system 200. One supplier of such database items is Oracle Corporation, of Redwood Shores, Calif. Moreover, software tools such as EDI, FTP, HTTP, HTML, XML, cXML, XSL, and WAP can be utilized for communications between information devices. Additionally, system 200 can utilize platform-independent and/or network-centric software tools such as, for example, Java or JavaScript.

Any input/output (I/O) device 3500 can be an audio and/or visual device, including, for example, a monitor, display, keyboard, keypad, touchpad, pointing device, microphone, speaker, video camera, camera, scanner, and/or printer, including a port to which an I/O device can be attached or connected.

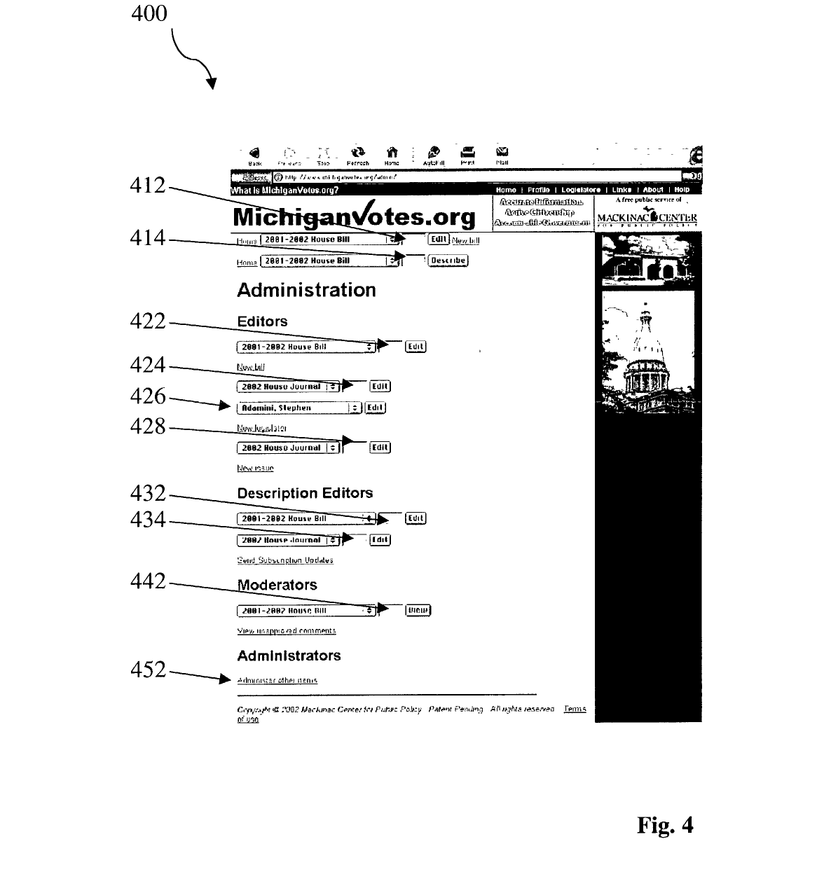

FIG. 4

FIG. 4 is a diagram of an exemplary embodiment of a user interface 400 of the present invention. User interface 400 can be used to edit and/or administer the database, and includes a number of management user interface elements 412 through 452. As used herein, a “user interface element” can be any known user interface structure, including for example, a window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, image, icon, button, control, dial, slider, scroll bar, cursor, status bar, stepper, and/or progress indicator etc.

Management user interface elements 412, 414, and 452 are only accessible by a user with the highest security level, which is called “administrator”. Management user interface elements 422, 424, 426, and 428 are only accessible by a user with the next highest security level or above, which is called “Editor”. Management user interface elements 432 and 434 are only accessible by a user with the next highest security level or above, which is called “Description Editor”. Management user interface element 442 is only accessible by a user with the next highest security level or above, which is called “Moderator”.

In text box 412 a bill number can be entered to gain access to a screen in which legislative activities regarding the bill can be entered and/or edited. Similarly in text box 414 a bill number can be entered to gain access to a screen in which a description of the substance of the bill can be entered and/or edited.

Text box 422 functions similarly to text box 412. In text box 424 a journal number can be entered to gain access to a screen where a description of all activities and bills associated with that journal number are cross-referenced. From pop-down list 426 a legislator can be selected to gain access to a screen in which legislator information can be entered and/or edited. The legislator information can include the house and/or party to which the legislator belongs, the legislator's starting date, the legislator's term end date, an identification of the legislator's district, and/or how the legislator's name appears in the journal. In text box 428 a bill number can be entered to gain access to a screen in which information regarding a particular journal can be entered and/or edited, such as the journal number and date(s). Text box 432 functions similarly to text box 414. Text box 434 functions similarly to text box 424, but leads to a screen appropriate for description editors. In text box 442 a bill number can be entered to gain access to a screen in which public comment titles and/or content can be entered, edited, and/or approved. Link 452 can be clicked to gain access to a screen on which an administrator can create and/or edit:

accounts for the web site and/or database;

entities (such as committees);

sessions; and/or

journals, etc.

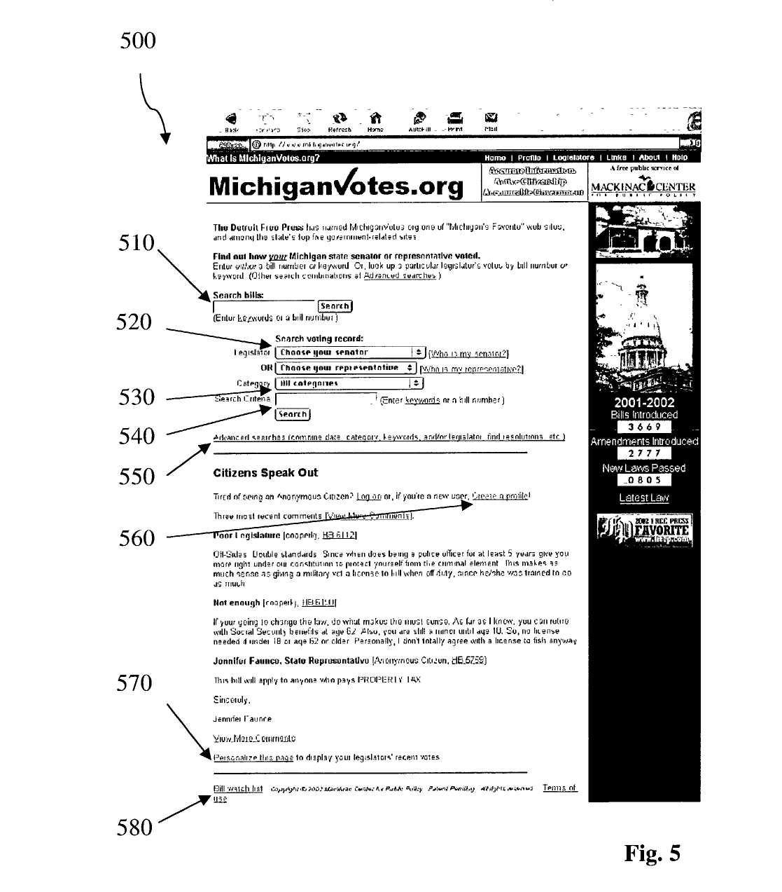

FIG. 5

FIG. 5 is a diagram of an exemplary embodiment of a user interface 500 of the present invention. User interface 500 can be used to query the database, and includes a number of basic query user interface elements 510 through 580. For example, in text box 510 a bill number or keyword can be entered to gain access to a screen in which legislative activities regarding the bill can be viewed.

From pop-down lists 520 a legislator can be selected to gain access to a screen in which legislative activities associated with that legislator can be viewed. In conjunction with pop-down lists 520, from pop-down lists 530 a category can be selected to gain access to a screen in which legislative activities associated with that category and that legislator can be viewed. Text box 540 functions similarly to text box 510, except that it returns bills or keywords associated with the selected legislator. Link 550 can be clicked to gain access to a screen on which an advanced query can be entered.

Link 560 can be clicked to gain access to a screen on which a profile can be created for a user who wishes to comment on a bill. Link 570 can be clicked to gain access to a screen on which particular legislators can be selected so that legislative activities involving those legislators are displayed on user interface 500.

Link 580 can be clicked to gain access to a screen on which the user can specify the types of activities the user would like to be notified about, including particular bills and/or bills regarding certain categories, keywords, and/or legislators. A notice can be sent to the user's e-mail address following each legislative session day showing all activities on bills meeting the user's criteria.

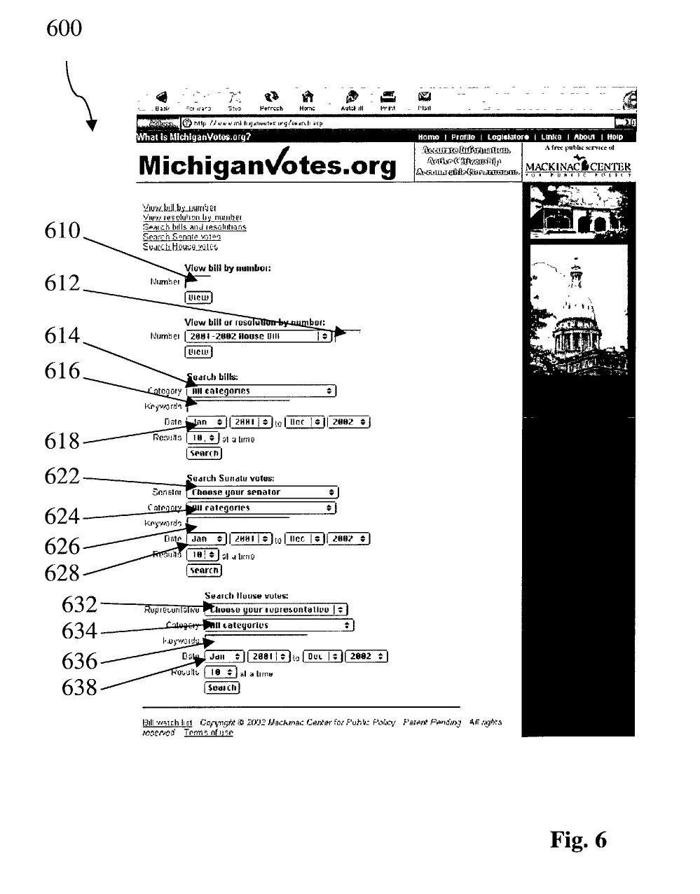

FIG. 6

FIG. 6 is a diagram of an exemplary embodiment of a user interface 600 of the present invention. User interface 600 can be used to query the database, and includes a number of advanced query user interface elements 610 through 638. For example, in text box 610 a bill number can be entered to gain access to a screen in which legislative activities regarding the bill can be viewed. Similarly, in text box 612 a bill number can be entered for a particular session of a particular legislative body (e.g., House or Senate) to gain access to a screen in which legislative activities regarding the bill can be viewed.

From pop-down lists 614 a category can be selected to gain access to a screen in which legislative activities associated with that category can be viewed. In conjunction with pop-down list 614, in text box 616 a keyword can be entered to gain access to a screen in which legislative activities associated with that category and that keyword can be viewed. Similarly, from pop-down lists 618 one or more dates can be selected to gain access to a screen in which legislative activities associated with that category, dates, and/or keyword can be viewed.

From pop-down lists 622 a legislator can be selected to gain access to a screen in which legislative activities associated with that legislator can be viewed. In conjunction with pop-down list 622, from pop-down list 624 a category can be entered to gain access to a screen in which legislative activities associated with that legislator and that category can be viewed. Similarly, in text box 626 one or more keywords can be entered, and from pop down lists 628 one or more dates can be selected.

Text box 540 functions similarly to text box 510, except that it returns bills or keywords associated with the selected legislator. Link 550 can be clicked to gain access to a screen on which an advanced query can be entered.

Advanced query user interface elements 632 through 638 function similarly as advanced query user interface elements 622 through 628, except rather than Senate activities, they address House activities.

Although the invention has been described with reference to specific embodiments thereof, it will be understood that numerous variations, modifications and additional embodiments are possible, and accordingly, all such variations, modifications, and embodiments are to be regarded as being within the spirit and scope of the invention. Also, references specifically identified and discussed herein are incorporated by reference as if fully set forth herein. Accordingly, the drawings and descriptions are to be regarded as illustrative in nature, and not as restrictive.

What is claimed is:

1. A computer-implemented method comprising:
rendering an entry user interface via which a database can be populated with information regarding a legislative activity, the entry user interface comprising data entry elements for individual legislator voting information, legislative activity identifier, and legislative activity description; and
populating the database with the information regarding the legislative activity.

2. The computer-implemented method of claim 1, further comprising:
reviewing the legislative activity.

3. The computer-implemented method of claim 1, further comprising:
analyzing the legislative activity.

4. The computer-implemented method of claim 1, further comprising:
distilling a content of the legislative activity into a description of the legislative activity.

5. The computer-implemented method of claim 1, further comprising:
distilling a content of the legislative activity into a description of the legislative activity, and
populating the database with the description.

6. The computer-implemented method of claim 1, further comprising:
providing a query user interface via which a query of the populated database can be entered.

7. The computer-implemented method of claim 1, further comprising:
providing a query user interface adapted to facilitate a query of the populated database.

8. The computer-implemented method of claim 1, further comprising:
receiving a query of the populated database.

9. The computer-implemented method of claim 1, further comprising:
receiving a query regarding the legislative activity.

10. The computer-implemented method of claim 1, further comprising:
automatically searching the populated database for a legislative activity corresponding to a query.

11. The computer-implemented method of claim 1, further comprising:
automatically searching the populated database for a bill corresponding to a date.

12. The computer-implemented method of claim 1, further comprising:
automatically searching the populated database for a bill corresponding to a date range.

13. The computer-implemented method of claim 1, further comprising:
automatically searching the populated database for a bill corresponding to a subject matter category.

14. The computer-implemented method of claim 1, further comprising:
automatically searching the populated database for an amendment corresponding to a subject matter category.

15. The computer-implemented method of claim 1, further comprising:
automatically rendering at least a portion of the information regarding the legislative activity in response to a query of the populated database.

16. The computer-implemented method of claim 1, further comprising:
providing a user interface via which a structure of the database can be created.

17. The computer-implemented method of claim 1, further comprising:
providing a user interface via which the information can be edited.

18. The computer-implemented method of claim 1, further comprising:
providing a user interface via which the database can be maintained.

19. The computer-implemented method of claim 1, further comprising:
providing a user interface via which a legislative activity can be selected.

20. The computer-implemented method of claim 1, further comprising:
providing a user interface via which an e-mail regarding a selected legislative activity can be generated.

21. The computer-implemented method of claim 1, further comprising:
providing a user interface via which an e-mail to a legislator associated with a selected legislative activity can be generated.

22. The computer-implemented method of claim 1, wherein the information regarding the legislative activity includes a description of the legislative activity.

23. The computer-implemented method of claim 1, wherein the information regarding the legislative activity includes a description of the legislative activity distilled from a content of a bill.

24. The computer-implemented method of claim 1, wherein the information regarding the legislative activity includes a legislative history of the legislative activity.

25. The computer-implemented method of claim 1, wherein the information regarding the legislative activity includes a title of the legislative activity.

26. The computer-implemented method of claim 1, wherein the information regarding the legislative activity includes a number of the legislative activity.

27. The computer-implemented method of claim 1, wherein the information regarding the legislative activity includes a sponsor of the legislative activity.

28. The computer-implemented method of claim 1, wherein the information regarding the legislative activity includes a legislative session within which the legislative activity occurred.

29. The computer-implemented method of claim 1, wherein the information regarding the legislative activity includes a date on which the legislative activity occurred.

30. The computer-implemented method of claim 1, wherein the information regarding the legislative activity includes a chamber within which the legislative activity occurred.

31. The computer-implemented method of claim 1, wherein the information regarding the legislative activity includes a procedural posture of the legislative activity.

32. The computer-implemented method of claim 1, wherein the information regarding the legislative activity includes a committee which is currently handling the legislative activity.

33. The computer-implemented method of claim 1, wherein the information regarding the legislative activity includes an amendment to the legislative activity.

34. The computer-implemented method of claim 1, wherein the information regarding the legislative activity includes a voting record associated with the legislative activity.

35. The computer-implemented method of claim 1, wherein the information regarding the legislative activity includes an executive branch status of the legislative activity.

36. The computer-implemented method of claim 1, wherein the information regarding the legislative activity includes an indication of whether the legislative activity has been approved by an executive.

37. The computer-implemented method of claim 1, wherein the information regarding the legislative activity includes an indication of whether the legislative activity has been vetoed.

38. The computer-implemented method of claim 1, wherein the information regarding the legislative activity includes an indication of whether the legislative activity has become law.

39. The computer-implemented method of claim 1, wherein the entry user interface further comprises a data entry element for subject matter category.

40. The computer-implemented method of claim 1, wherein the entry user interface further comprises a data entry element for legislative activity date.

41. The computer-implemented method of claim 1, wherein the entry user interface further comprises a data entry element for public comments.

42. A computer-readable medium containing instructions for actions comprising:
rendering a user interface via which a database can be populated with information regarding a legislative activity, the user interface comprising data entry elements for individual legislator voting information, legislative activity identifier, and legislative activity description; and
populating the database with the information regarding the legislative activity.

43. A computer-implemented system comprising:
means for rendering a user interface via which a database can be populated with information regarding a legislative activity, the user interface comprising data entry elements for individual legislator voting information, legislative activity identifier, and legislative activity description; and
means for populating the database with the information regarding the legislative activity.

44. A graphical user interface comprising:
an individual legislator voting information element;
a legislative activity identifier element; and
a legislative activity description element.

45. A computer-implemented method comprising:
obtaining information regarding a legislative activity; and
providing the information regarding the legislative activity to a plurality of fields of a database, the plurality of fields comprising fields for individual legislator voting information, legislative activity identifier, and legislative activity description.

46. A computer-implemented method comprising:
rendering a user interface via which a database can be populated with information regarding a legislative activity, the user interface comprising data entry elements for legislative activity identifier, legislative activity description, and public comments; and
populating the database with the information regarding the legislative activity.

47. A computer-implemented system comprising:
means for rendering a user interface via which a database can be populated with information regarding a legislative activity, the user interface comprising data entry elements for legislative activity identifier, legislative activity description, and public comments; and
means for populating the database with the information regarding the legislative activity.
